(19) United States
(12) Patent Application Publication
(10) Pub. No.: US 2006/0249636 A1
(43) Pub. Date: Nov. 9, 2006

(54) Mounting system for guiding and fastening one or several pipes or similarly formed objects

(76) Inventors: Jens Thiedig, Stuhr (DE); Guenter Mail, Stuhr (DE)

Correspondence Address: OSTROLENK FABER GERB & SOFFEN, 1180 AVENUE OF THE AMERICAS, NEW YORK, NY, 100368403, US

(21) Appl. No.: 11/368,868

(22) Filed: Mar. 6, 2006

Related U.S. Application Data
(60) Provisional application No. 60/660,213, filed on Mar. 10, 2005.

(30) Foreign Application Priority Data
Mar. 10, 2005 (DE) 102005011131.9

(51) Int. Cl. F16L 3/08; F16L 3/12

(52) U.S. Cl. 248/74.4; 248/74.1

(57) ABSTRACT

A mounting for guiding and fastening at least one element, wherein the mounting comprises a first mounting component, a second mounting component and a dampening device wherein in the first mounting component and in the second mounting component recesses are provided through which in the state in which the first mounting component and the second mounting component are put together, the at least one element can be accommodated, and wherein the dampening device is provided in the recesses such that in the state in which the first mounting component and the second mounting component have been put together, the at least one element is essentially surrounded on its entire circumference by the dampening device. With the mounting and the connecting elements, the following installations can be carried out: unequivocally positionable and fastenable on a connecting component on a connecting component with lateral slidability and fastenability fixable on the element to be mounted, without a connecting component.

This application claims the benefit of the filing date of German Patent Application No. 10 2005 011 131.9 filed Mar. 10, 2005 and of U.S. Provisional Patent Application No. 60/660,213 filed Mar. 10, 2005, the disclosure of which is hereby incorporated herein by reference.

### FIELD OF THE INVENTION

The invention relates to a mounting, to a method for guiding and fastening at least one element, to an aircraft, and to the use of a mounting in an aircraft.

### TECHNOLOGICAL BACKGROUND

It is known to guide and fasten cables or pipes in a mounting.

FR 2029254 discloses a guide for bunches of cables that are to be routed underground as telephone lines.

The German utility model of roll number G 82 31 264.8 discloses a pipe holder for attaching several pipelines with attachment bolts and a retaining component arranged thereon and attached between nuts.

DE 197 52 525 C1 discloses a pipe holder with vibration dampening, in which pipe holder a base body with a body plate and U-shaped sidewalls as well as a retaining shell that encompasses more than half of a pipeline circumference are provided. In order to fasten the pipelines after they have been pushed into place, on the upper end of one of the sidewalls a closing hoop is hingeably formed, which closing hoop can be folded over so that it interacts with a counter snap-in edge.

Due to manufacturing tolerances in the installation of conventionally used mountings jamming and play between the mountings and the pipes may result. Such a state can have a negative effect on the mountings and the pipes during vibration or shock.

Furthermore, mounting known pipe holders is frequently expensive and complicated.

### SUMMARY OF THE INVENTION

According to exemplary embodiments of the invention, a mounting, a method for guiding and fastening at least one element, an aircraft and a method of using a mounting in an aircraft with the features according to the independent claims are provided.

According to exemplary embodiments of the invention, it may be made possible to guide and fasten elements in a cost-effective manner and in such a way that they are protected from vibration or shock.

According to an exemplary embodiment of the invention, a mounting for guiding and fastening at least one element is provided, which mounting comprises a first mounting component, a second mounting component and a dampening device. In the first mounting component and in the second mounting component, recesses can be provided through which, in the state in which the first mounting component and the second mounting component are put together, the at least one element can be accommodated. The dampening device can be provided in the recesses such that in the state in which the first mounting component and the second mounting component are put together, the at least one element is essentially surrounded on its entire circumference by the dampening device.

According to another exemplary embodiment of the invention a method for guiding and fastening at least one element is created, wherein the at least one element is accommodated by recesses in a first mounting component and in a second mounting component. The first mounting component can be put together with the second mounting component. A dampening device can be provided in the recesses such that after the first mounting component and the second mounting component have been put together, the at least one element is essentially surrounded on its entire circumference by the dampening device.

According to another exemplary embodiment of the invention, an aircraft with a mounting with the above-described features is created.

According to yet another embodiment of the invention the use of a mounting with the above-described features in an aircraft is taught.

One exemplary aspect of the invention can be seen in that a dampening device is provided so as to be integrated in recesses for accommodating an element to be guided and fastened, which dampening device in its state when the two mounting components are put together surrounds the element along its entire circumference. As a result of this, a cost-effective mounting may be created, which can for example be manufactured with the use of injection-moulding technology, in which a guided and fastened element (for example a pipe) by means of the dampening device can safely be protected against vibration or shock and consequently against rattling, and can be prevented from changing its position in an undesirable way both in radial direction and in axial direction (in axial direction in particular by means of special measures on the element to be mounted).

In other words, according to an exemplary embodiment of the invention, a mounting system for guiding and fastening one or several pipes or similarly shaped objects is created. This pipe attachment system may be in particular suitable for hydraulic pipes and can for example be implemented in, or retrofitted to, an aircraft (for example an aircraft of the Airbus fleet). The fastening system according to an exemplary embodiment of the invention, can guide pipes, dampen pipe vibration and ensure specific pull-through forces of the pipes. The mounting may be light in weight, comprises few individual components, can be preassembled and may be cost-effective to produce, use and install. The dampening zones can be firmly integrated in the pipe mounting and can be made from the same material as the pipe mounting. The mounting according to an exemplary embodiment of the invention, may thus ensure safe and defined accommodation and guidance of pipelines or other elements such as for example cables.

Due to its light weight and its ability to be easily preassembled as well as its ability to be manufactured economically, the mounting according to an exemplary embodiment of the invention, may be well suited to use in an aircraft.

According to an exemplary embodiment of the invention, a mounting system for guiding and fastening one or several pipes or similarly formed objects with and without fastening to a connecting component is created. Accommodating a pipe can take place by way of half-shells, wherein each shell can be situated in a mounting half so as to enclose the pipe in that the two mounting halves are brought together. Such mountings can be used as a fastening system for hydraulic pipelines in Airbus aircraft.

In a holder according to one exemplary embodiment of the invention by specially designed guidance of the pipes, play or excessive clamping can be prevented or reduced. Furthermore, in the case of movement and vibration, the pipe can be dampened by this guide.

With a special connecting element system for screwing together the mounting halves, the ability to pre-assemble can be achieved. Furthermore, with the use of a single tool for tightening the connecting elements, installation of the mounting can be carried out. In conjunction with an elongated hole in a connecting component, installation on both sides and displacement across the longitudinal direction of the pipe can be made possible.

By means of a quick-acting closure or an additional bolt between the guides for the pipes, opening up of the mountings can be prevented and thus clamping and dampening of the pipes in an even manner can be achieved.

Further exemplary embodiments of the invention are stated in the dependent claims.

In the following, exemplary embodiments of the mounting according to the invention are described. These embodiments also apply to the method, their accommodation in an aircraft, and their use.

The mounting can be designed for guiding and fastening at least one pipe. Such a pipe can for example be a hydraulic pipe, in particular in a vehicle, including in an aircraft.

The dampening device can be provided so as to be integrated, preferably from a single material, in the first mounting component and/or in the second mounting component. In other words, the dampening device can be made from a single piece/integrally formed (i.e. as a common construction element) and if need be also from one material (i.e. from the same material) with the respective mounting components, which makes possible cost-effective manufacture.

The dampening device can be designed such that accommodation of the at least one element, which accommodation is essentially without play, and/or dampening in radial direction of the recesses and/or predefinable pull-through force for the at least one element in axial direction are/is implemented. This makes possible secure protection against the effects of vibration or shock.

The dampening device can comprise a foam material, a rubber and/or a spring device.

The dampening device can exert a mechanical (restoring) force in fully circumferential direction on the element that is to be guided and fastened, such that secure protection against vibration or shock in radial direction is possible while maintaining displacement (defined force of displacement) in axial direction. With the use of the spring principle, the dampening device can be implemented as a polygon-like component (for example as a regular hexagon) or it can be implemented so as to be wedge-like, wherein said component at each adjacent region to an element to be fastened exerts a restoring force on the element in case of dislocation, so that any undesired unguided movement of the element is prevented and/or dampened. In this way, rattling of the element in the guide according to the invention is prevented. If the dampening zone is implemented as a polygon-like component, it is also possible to even out tolerances of elements to be accommodated so that elements with flexible measurements (e.g. pipes) with standard diameter tolerances and differing surface characteristics (in relation to dimensions, surface protection, tolerances) can be used. A polygonal dampening device can comprise two semi-polygons which can have been placed in, or integrated in, the recesses of the mounting components.

The mounting elements can be implemented as two identical mounting halves by means of which the at least one element is enclosable over its entire circumference. For example, the retaining components can be cuboid solid bodies that comprise semi-cylindrical recesses to accommodate cylindrical pipes or cables and through-boreholes to screw the two mounting halves together. If the structure of the two mounting components is identical, cost-effective manufacture becomes possible and it is prevented to mix the mounting components up during installation.

In the first mounting component and in the second mounting component a plurality of recesses can be provided with which a plurality of elements can be accommodated. It is thus possible for a plurality of pipes to be guided, for example in parallel direction in relation to each other. Likewise, guiding of cables or other elements is possible.

The first mounting component can be screwable to the second mounting component. This provides a cost-effective option of connecting the two mounting components and facilitates installation.

Furthermore, a connection component can optionally be provided, wherein the first mounting component can be screwed to the second mounting component and to the connecting component. This connecting component is used as an interface between the mounting components and a base body for installing the mounting.

The mounting can comprise an anchor nut and a screw, which can be guided through boreholes in the first mounting component and in the second mounting component, and which for the purpose of fastening the first mounting component to the second mounting component can be screwed together. The anchor nut can be matched to the boreholes in such a way that automatic release of the first mounting component from the second mounting component is prevented. Furthermore, by means of special measures (for example a clip closure) automatic disconnection of the two mounting halves can be prevented in those cases where the two mounting halves and the anchor nut are installed without screws.

The anchor nut according to the invention can be designed such that for example it can be inserted through an elongated hole and subsequently, to protect it from falling from the elongated hole of a connecting component, can be rotated by 90°. For example, for this purpose the anchor nut can be of asymmetrical (for example oval or rectangular but not square) cross section. This makes possible overhead installation of the mounting without the anchor nut falling out of the elongated hole. The anchor nut can also be used for purposes other than for attaching the mounting according to the invention. The anchor nut makes possible quick and simple installation with a single tool (in conjunction with a component that is adapted to the anchor nut and that is to be screwed on).

In the connecting component, an elongated hole can be provided whose shape matches the shape of the anchor nut, and/or is adapted to the shape of the anchor nut, such that installation is possible on either side of the connecting component. Furthermore, slidability and/or adaptability of the two mounting components, for example transversely in relation to a direction of alignment of the at least one line element can be made possible in that the mounting components are fastened at a corresponding position of the elongated hole.

The mounting can be a quick-acting closure (or an additional bolt) to connect the first mounting component to the second mounting component so that any opening up of the first mounting component and the second mounting component is prevented. The term “quick-acting closure” refers to a closure with which the two mounting components can quickly and easily, i.e. “provisionally”, be interconnected, for example during installation. Permanent fastening of the two mounting components can subsequently take place with the use of some other closing device. The quick-acting closure can for example be a snap-in connection. The quick-acting closure can be integrated in the first mounting component and in the second mounting component, or it can be provided as a component that is separate from the first mounting component and the second mounting component (such as for example an additional bolt, or a screw and anchor nut).

With the mounting according to an exemplary embodiment of the invention and with the connecting elements, in particular the following installations can be carried out:
unequivocally positionable and fastenable on a connecting component
on a connecting component with lateral slidability and fastenability
fixable on the element to be mounted, without a connecting component.

Exemplary embodiments of the invention are shown in the figures and are explained in more detail below.

### BRIEF DESCRIPTION OF DRAWINGS

The following are shown:

FIG. 1 an exploded view of a mounting for pipes according to an exemplary embodiment of the invention.

FIG. 2 a view of the mounting for pipes, shown in FIG. 1, in an assembled state according to the exemplary embodiment of the invention.

### DESCRIPTION OF PREFERRED EMBODIMENTS OF THE INVENTION

Identical or similar components in different figures have the same reference characters. The illustrations in the figures are diagrammatic and not to scale.

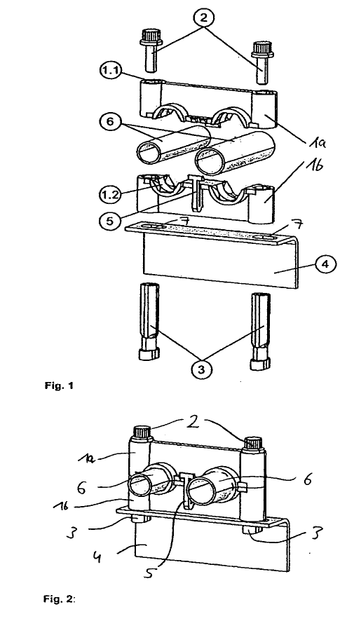

FIG. 1 and FIG. 2 show one embodiment of a mounting system for guiding and fastening pipes or similarly formed objects, according to an exemplary embodiment of the invention.

FIG. 1 shows a mounting to guide and fasten two pipes 6, wherein the mounting comprises a first mounting component 1a, a second mounting component 1b and a dampening device 1.2. In the first mounting component 1a and in the second mounting component 1b, recesses are provided by means of which in a put-together state of the first mounting component 1a and the second mounting component 1b the two pipes 6 can be accommodated. The dampening device 1.2 is provided in the recesses such that in a put-together state of the first mounting component 1a and second mounting component 1b the full circumference of the two pipes 6 is essentially surrounded by the dampening device 1.2.

The number of the pipes 6 to be attached to the mounting can be set by corresponding adaptation of the mounting. By means of bringing together two identical mounting halves 1a, 1b, the pipes 6 to be fastened can be enclosed by the guides 1.2. Interconnecting the two mounting halves 1a and 1b with or without a connecting component 4 can take place by way of screws 2 and anchor nuts 3 which can be installed through boreholes 1.1 in the mounting and through elongated holes 7 in the connecting component 4. The anchor nuts 3 and the boreholes 1.1 are designed such that installation is possible from either side of the connecting component 4, and only a single tool for tightening the connecting elements 2, 3 is necessary. The anchor nuts 3 and the boreholes 1.1 and a clip 5 comprise a device which prevents automatic disconnection of the two mounting halves if the anchor nuts 3 have been installed without screws 2 through the boreholes 1.1 of the two mounting halves 1a, 1b.

The guides 1.2 comprise dampening zones. During radial movement of the pipes 6 relative to the two mounting halves 1a, 1b, these zones deform, thus in each spring deflection state ensuring accommodation of the pipes 6 without play. The dampening zones are designed such that with increased deformation the deformation force and/or dampening force increases and the support surfaces for the pipes 6 become larger. Furthermore, a defined pull-through force for the pipes 6 is achieved in axial direction.

In the case of a mounting solution for accommodating several pipes 6, for the purpose of preventing the two mounting halves 1a, 1b from opening up, a quick-acting closure 5 or an additional bolt each is provided between the guides 1.2. This can be firmly integrated in the mounting or it can be a separate component (for example a screw and anchor nut).

In this way, according to the invention, a mounting for guiding and fastening pipes 6 or similarly shaped objects is provided. The mounting can comprise firmly integrated dampening zones on the guides 1.2 of the mounting for these pipes 6, which dampening zones in each spring state can ensure accommodation of the pipes 6 without play, as well as dampening in radial direction, and a defined pull-through force for the pipes 6 in axial direction. Two identical mounting halves 1a, 1b can fully enclose the pipes 6. With the mounting according to the invention, by varying the number of guides 1.2, one or several pipes 6 can be fastened. The mounting halves 1a, 1b can be screwed together with or without a connecting component 4 through connecting elements 2, 3. The mounting can ensure that certain spacing between the pipes 6 is maintained, as is the position of said pipes 6.

Furthermore, an anchor nut 3 with screw 2 can be used to connect the mounting halves 1a, 1b. To this effect a single tool is sufficient to tighten the screw 2 in conjunction with the anchor nut 3 extending through the borehole 1.1 of the mounting 1a and 1b. By way of special measures between the anchor nut 3 and the borehole 1.1 automatic disconnection of the two mounting halves 1a, 1b in the case of installation of the two mounting halves 1a, 1b and the anchor nuts 3 without screws 2 is prevented (for example by way of clip 5, or as an alternative by a third, central, anchor nut—not shown—affixed instead of clip 5).

The shape of the head of the anchor nut 3 in conjunction with an elongated hole 7 in the connecting component 4 can ensure that installation can take place on either side on the connecting component 4. Furthermore, installation can take place without the connecting component 4.

With the position of the elongated holes 7 in the connecting component 4, a mounting solution that is slidable in the direction of the elongated holes 7 or a fixed mounting solution can flexibly be selected.

By means of the quick-acting closure 5 for connecting the mounting halves 1a, 1b between the guides, opening up of the two mounting halves 1a and 1b can be prevented. This quick-acting closure 5 can either be firmly integrated in the mountings or it can be designed as an additional design element.

In addition it should be pointed out that “comprising” does not exclude other elements or steps, and “a” or “one” does not exclude a plural number. Furthermore, it should be pointed out that features or steps which have been described with reference to one of the above embodiments can also be used in combination with other features or steps of other embodiments described above. Reference characters in the claims are not to be interpreted as limitations.

What is claimed is:

1. A mounting for guiding and fastening at least one element, wherein the mounting comprises
a first mounting component;
a second mounting component;
a dampening device;
wherein in the first mounting component and in the second mounting component, recesses are provided through which in a state in which the first mounting component and the second mounting component are put together, the at least one element can be accommodated;
wherein the dampening device is provided in the recesses such that in a state in which the first mounting component and the second mounting component are put together, the at least one element is essentially surrounded on its entire circumference by the dampening device, and wherein the dampening device is provided integrated with the first mounting component and the second mounting.

2. The mounting of claim 1,
designed for guiding and fastening at least one pipe.

3. The mounting of claim 1,
in which the dampening device, the first mounting component and the second mounting component are made from a single material.

4. The mounting of claim 1,
in which the dampening device is designed such that accommodation, which is without play, of the at least one element and/or dampening in radial direction of the recesses and/or predefinable pull-through force for the at least one element in axial direction of the at least one element is implemented.

5. The mounting of claim 1,
in which the dampening device comprises at least one of the group consisting of a foam material padding, a rubber, and a spring.

6. The mounting of claim 1,
in which the first mounting component and the second mounting component are implemented as two identical mounting halves by means of which the at least one element is enclosable over its entire circumference.

7. The mounting of claim 1,
wherein in the first mounting component and in the second mounting component a plurality of recesses are provided with which a plurality of elements can be accommodated.

8. The mounting of claim 1,
wherein the first mounting component can be screwed to the second mounting component.

9. The mounting of claim 1,
further comprising a connecting component, wherein the first mounting component can be screwed to the second mounting component and to the connecting component.

10. The mounting of claim 8,
comprising an anchor nut and a screw, which can be fed through boreholes in the first mounting component and in the second mounting component, and which for the purpose of fastening the first mounting component to the second mounting component can be screwed together.

11. The mounting of claim 10,
wherein the anchor nut and the boreholes are matched to one another in such a way that automatic release of the first mounting component from the second mounting component is prevented.

12. The mounting of claim 10,
wherein in the connecting component an elongated hole is provided whose shape matches the shape of the anchor nut such that installation is possible on both sides of the connecting component, and/or such that slidability of the first mounting component and the second mounting component transverse to a direction of alignment of the at least one element is possible.

13. The mounting of claim 1,
comprising a quick-acting closure to connect the first mounting component to the second mounting component so that opening up of the first mounting component and of the second mounting component is prevented.

14. The mounting of claim 13,
in which the quick-acting closure is a snap-in connection.

15. The mounting of claim 13,
in which the quick-acting connection is integrated in the first mounting component and in the second mounting component.

16. The mounting of claim 13,
in which the quick-acting connection is provided as a component that is separate from the first mounting component and the second mounting component.

17. The mounting of claim 1,
in which the dampening device is simultaneously designed as a guide device for guiding the at least one element.

18. An aircraft,
comprising a mounting of claim 1.

19. A method of guiding and fastening at least one element,
wherein the method comprises
accommodating the at least one element by recesses in a first mounting component and in a second mounting component;
putting together the first mounting component and the second mounting component;
providing a dampening device in the recesses such that after the first mounting component and the second mounting component have been put together, the at least one element is essentially surrounded on its entire circumference by the dampening device, and
providing the dampening device integrated with the first mounting component and the second mounting.

20. A method of using a mounting of claim 1, wherein the method comprises using the mounting in an aircraft.
